(19) United States
(12) Patent Application Publication
(10) Pub. No.: US 2012/0295237 A1
(43) Pub. Date: Nov. 22, 2012

(54) EXERCISE REWARD CONTAINER

(76) Inventors: MARIA APELO CRUZ JOVANOVIC, Encino, CA (US); Misko Jovanovic, Encino, CA (US)

(21) Appl. No.: 13/111,296

(22) Filed: May 19, 2011

(51) Int. Cl. G09B 19/00

(52) U.S. Cl. 434/236

(57) ABSTRACT

Motivation for performing exercise may be provided with an exercise reward holding system. The system may include a pedometer and a container to hold a reward object. The container may have a lock programmable to release upon receipt of a signal from the pedometer. The pedometer may be operable in a location separate from the container.

### BACKGROUND OF THE INVENTION

The present invention generally relates to exercise equipment and more particularly to devices for providing motivation to a person.

While many people engage in physical exercise based exclusively on their own internal motivation, it is well known that some people engaging in an exercise program may benefit from external motivation. Indeed, there are various exercise machines which incorporate sensors such as mileage counters or calorie counters to trigger issuance of reward coupons to an exerciser after the exerciser has performed a pre-set amount of physical activity on the exercise machine.

Some people may elect to perform an exercise program that may include outdoor activities such as, for example, biking, running, walking or rowing. For these activities, there are presently no systems for measuring expenditure of physical effort and providing a corresponding reward based upon meeting a preset level of activity.

As can be seen, there is a need for a system of providing external motivation to a person to perform a preset amount of physical exercise in a setting which is independent of an exercise machine, for example outdoor exercise.

### SUMMARY OF THE INVENTION

In one aspect of the present invention, an exercise reward holding system may comprise: a pedometer; a container; and a lock programmable to release upon receipt of a signal from the pedometer, the pedometer being operable in a location separate from the container.

In another aspect of the present invention, an exercise reward container may comprise: a containment cylinder; an enclosure cap with a programmable lock; a pedometer configured to be inserted in a receptacle of the enclosure cap; and an electronics board configured to convey programming information to the programmable lock and to the pedometer simultaneously during programming of the lock.

In still another aspect of the invention, a method for providing motivation to an exerciser may comprise the steps of: providing for placing a reward object into a container; providing for locking the container with a programmable lock; providing for programming the lock with an exercise goal parameter; and providing for signaling the programmable lock with a pedometer that has recorded exercise activity that is at least equivalent to the programmed exercise goal parameter to open the programmable lock and to release the reward object to the exerciser.

These and other features, aspects and advantages of the present invention will become better understood with reference to the following drawings, description and claims.

### BRIEF DESCRIPTION OF THE DRAWINGS

FIG. 1 is a perspective view of an operational feature of an exercise reward container in accordance with an embodiment of the invention;

FIGS. 2 and 3 are perspective views of the container of FIG. 1;

FIG. 4 is a cross-sectional view of the container of FIG. 1;

FIG. 5 is a perspective view of another embodiment of an exercise reward container in accordance with the invention;

FIGS. 6 and 7 are perspective views of pedometers of the container of FIG. 5; and

FIG. 8 is a cross sectional view of the container of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a system in which a lockable container may be pre-loaded with an object or material and then programmed to open only after receiving a signal that confirms that a preset amount of exercise efforts has been expended by a person. More particularly, the container may open responsively to a signal emanating from a recording device carried by the person.

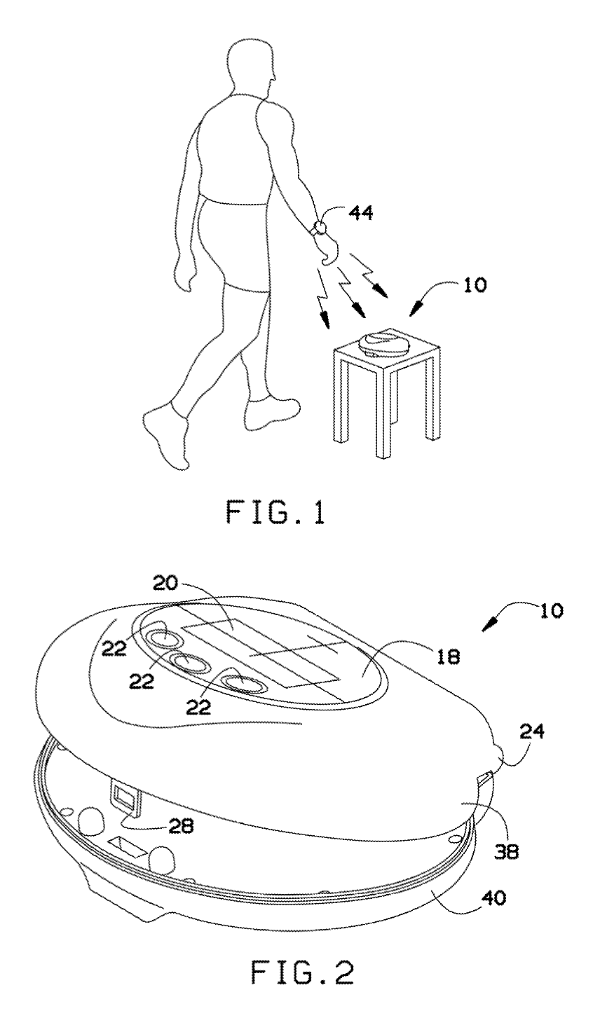

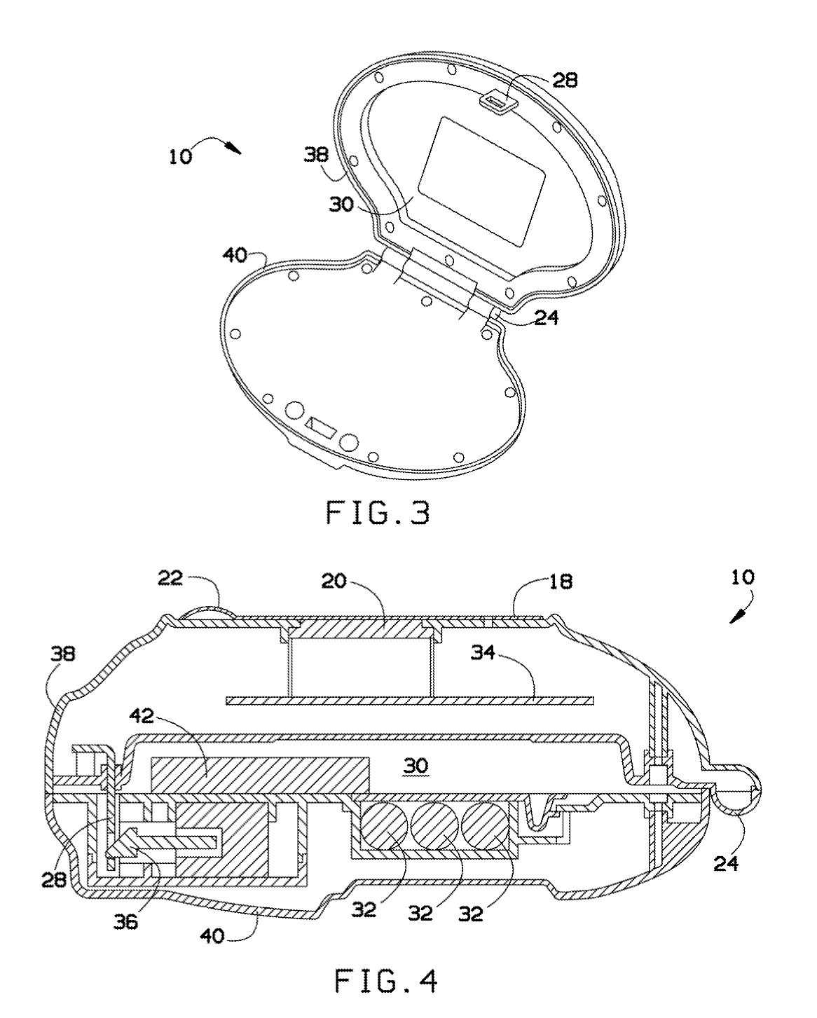

Referring now to the FIGS. 1 through 4, an exemplary embodiment of an exercise reward container 10 may be seen to comprise, a membrane panel 18, a display 20, input buttons 22, a spring hinge 24, a mounting ring 26, a switch lock 28, a reward compartment 30, batteries 32, an electronic component board 34, a locking pawl 36, an upper housing 38 and a lower housing 40.

In operation, a reward object 42 may be placed into the reward container 10 by a prospective exerciser or by a coach of the exerciser or some other third party who may elect to provide motivation to the exerciser. The input buttons 22 may be employed to program the container 10 to open in response to a signal indicative of a particular expenditure of energy by the exerciser. For example, the buttons 22 may be employed to program exercise goal parameters such as a particular mileage or elapsed time or completion of mileage within an elapsed time. Programmed exercise goal parameters may be displayed on the display 20. The container 10 may be closed and locked after being loaded with the reward object 42 and programmed with desired exercise goal parameters.

The exerciser may perform his or her exercise while wearing or carrying a recording device such a wireless pedometer 44. Upon completion of exercise, the exerciser may bring the pedometer 44 into proximity with the container 10. If signals from the pedometer indicate that programmed exercise goal parameters have been met, the container 10 may unlock. The exerciser may then remove the reward object 42 from the container 10.

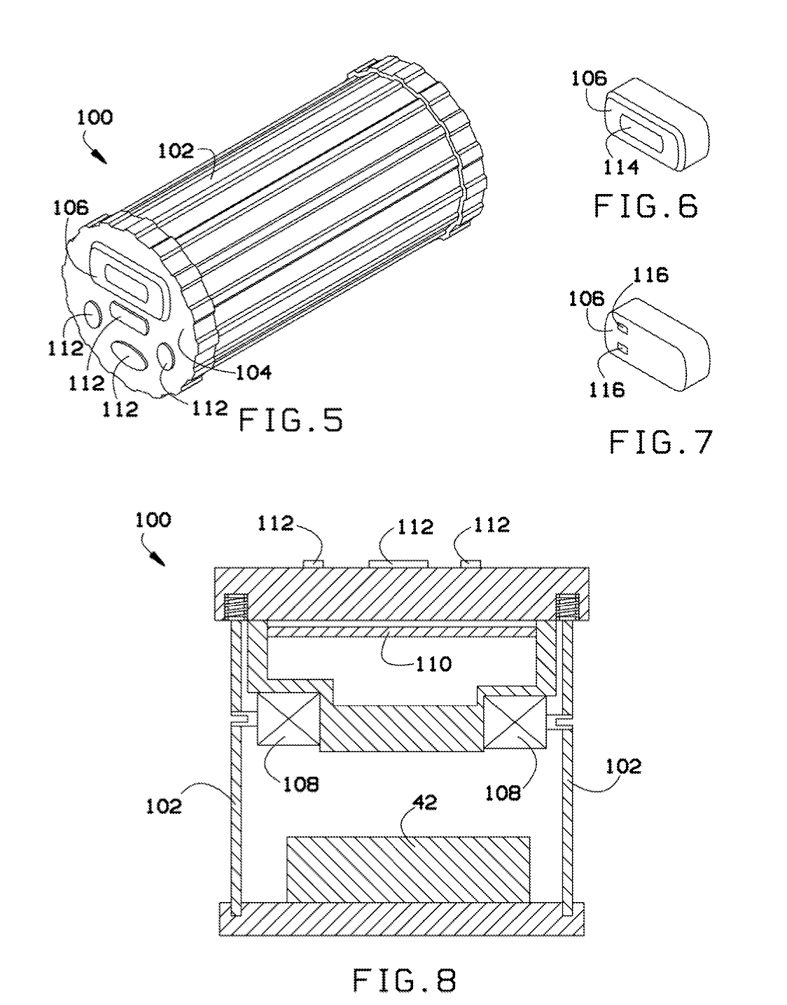

Referring now to FIGS. 5-8, another embodiment of a reward container 100 may be seen to comprise a containment cylinder 102, an enclosure cap 104 and a removable pedometer 106. The enclosure cap 104 may include one or more solenoid locks 108, an electronics board 110, and programming buttons 112. The pedometer 106 may include a display 114 and electrical contacts 116 through which electrical connection may be made between the pedometer 106 and the enclosure cap 104.

In operation, the reward object 42 may be placed in the container 100. Then the buttons 112 may be used to program the exercise goal parameters. The pedometer 106 may be in position in the enclosure cap during the programming so that both the enclosure cap 104 and the pedometer 106 may be simultaneously programmed with the exercise goal parameters. After programming is complete, the locks 108 may engage with the cylinder 102 and the container 100 may thus be locked.

The pedometer 106 may be removed from the cap 104 and carried by the exerciser. Upon completion of exercise, the pedometer 106 may be inserted into the cap 104. If the pedometer 106 indicates that the exercise goal parameters are met, the locks 108 may release and the cap 104 may be removed from the cylinder 102, thus allowing access to the reward object 42.

Optionally, a universal serial bus (USB) connector or wireless connection for the pedometer 106 may allow for connection to the internet for an override code to be used to open the container 100. There could be a charge for using this service and a record emailed to an owner of the container 100.

It should be understood, of course, that the foregoing relates to exemplary embodiments of the invention and that modifications may be made without departing from the spirit and scope of the invention as set forth in the following claims.

What is claimed is:

1. An exercise reward holding system comprising:
a pedometer;
a container; and
a lock programmable to release upon receipt of a signal from the pedometer,
the pedometer being operable in a location separate from the container.

2. The exercise reward holding system of claim 1 wherein the programmable lock is configured to release upon receipt of a wireless signal from the pedometer.

3. The exercise reward holding system of claim 1 further comprising an electronics board configured to convey programming information to the programmable lock and to the pedometer simultaneously during programming.

4. The exercise reward holding system of claim 3 wherein the container comprises:
an enclosure cap with integral solenoid locks; and
a containment cylinder configured to be locked to the enclosure cap with the solenoid locks.

5. An exercise reward container comprising:
a containment cylinder;
an enclosure cap with a programmable lock;
a pedometer configured to be inserted in a receptacle of the enclosure cap; and
an electronics board configured to convey programming information to the programmable lock and to the pedometer simultaneously during programming of the lock.

6. The container of claim 5 wherein the programmable lock is a solenoid lock.

7. The container of claim 5 wherein the pedometer has a display that shows a value of an exercise goal parameter programmed into the programmed lock.

8. A method for providing motivation to an exerciser comprising the steps of:
Providing for placing a reward object into a container;
Providing for locking the container with a programmable lock;
Providing for programming the lock with an exercise goal parameter; and
Providing for signaling the programmable lock with a pedometer that has recorded exercise activity that is at least equivalent to the programmed exercise goal parameter to open the programmable lock and to release the reward object to the exerciser.

9. The method of claim 8 wherein programming the lock is performed by pressing buttons on the container and said pressing of buttons programs the pedometer with the exercise goal parameter.

10. The method of claim 9 wherein signaling the programmable lock to open comprises inserting the pedometer into the container.
